(19) United States
(12) Patent Application Publication
(10) Pub. No.: US 2025/0390159 A1
(43) Pub. Date: Dec. 25, 2025

(54) ELECTRONIC DEVICE, STORAGE MEDIUM, AND MODE SWITCHING METHOD

(71) Applicant: CASIO COMPUTER CO., LTD., Tokyo (JP)

(72) Inventors: Yousuke NAKAMURA, Tokyo (JP); Asuka KUNUGI, Tokyo (JP); Kosuke HASEGAWA, Tokyo (JP)

(73) Assignee: CASIO COMPUTER CO., LTD., Tokyo (JP)

(21) Appl. No.: 19/237,385

(22) Filed: Jun. 13, 2025

(30) Foreign Application Priority Data
Jun. 21, 2024 (JP) 2024-100556

(51) Int. Cl. G06F 1/3231; G06F 1/16

(52) U.S. Cl. CPC G06F 1/3231; G06F 1/163

(57) ABSTRACT

An electronic device includes a brightness information acquirer and a controller. The brightness information acquirer acquires brightness information regarding brightness of surroundings of the electronic device. The controller performs at least one judgment to switch a mode of the electronic device from a first mode to a second mode which operates with lower power consumption than the first mode or to switch the mode from the second mode to the first mode based on a different switching condition between a case in which it is judged that the surroundings of the electronic device are bright and a case in which it is judged that the surroundings of the electronic device are not bright based on the acquired brightness information.

### CROSS-REFERENCE TO RELATED APPLICATIONS

This application is based upon and claims the benefit of priority from the prior Japanese Patent Application No. 2024-100556, filed on Jun. 21, 2024, the entire contents of which are incorporated herein by reference.

### BACKGROUND OF THE INVENTION

### Field of the Invention

The present invention relates to an electronic device, a storage medium, and a mode switching method.

### Description of the Related Art

For example, Japanese Unexamined Patent Application Publication No. 2017-68499 discloses an electronic device that acquires position information or posture information of a user, judges a state of the user based on the acquired position or posture information, and switches from normal mode to power saving mode according to the judgment result.

### SUMMARY OF THE INVENTION

The electronic device according to the present disclosure includes,
a brightness information acquirer that acquires brightness information regarding brightness of surroundings of the electronic device; and
a controller that performs at least one judgment to switch a mode of the electronic device from a first mode to a second mode which operates with lower power consumption than the first mode or to switch the mode from the second mode to the first mode based on a different switching condition between a case in which it is judged that the surroundings of the electronic device are bright and a case in which it is judged that the surroundings of the electronic device are not bright based on the acquired brightness information.

### BRIEF DESCRIPTION OF THE DRAWINGS

FIG. 1 is a block diagram showing an example of a configuration of an electronic timepiece.

FIG. 2 is a flowchart showing a flow of a mode switching process executed by a controller shown in FIG. 1.

FIG. 3 is a flowchart showing a flow of a judgment process for switching to a power saving mode executed in step S3 of FIG. 1.

FIG. 4 is a flowchart showing a flow of a judgment process for switching to a normal mode executed in step S4 of FIG. 1.

### DETAILED DESCRIPTION

Hereinafter, embodiments to implement present disclosure are described with reference to the drawings. However, various limitations that are technically preferable to execute the present disclosure are described in the embodiments below. Therefore, the technical scope of the present disclosure is not limited to the embodiments described below and the illustrated examples.

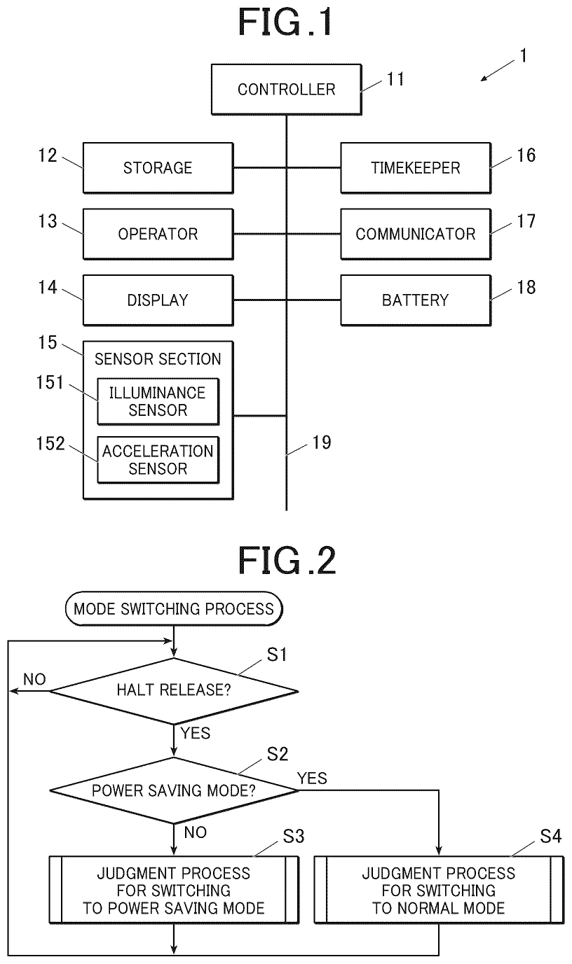

First, an example configuration of an electronic timepiece 1 according to the present embodiment is described. As shown in FIG. 1, the electronic timepiece 1 includes a controller 11, a storage 12, an operator 13, a display 14, a sensor section 15, a timekeeper 16, a communicator 17, and a battery 18 and each unit is connected to each other through a bus 19.

The controller 11 includes a CPU (Central Processing Unit), a RAM (Random Access Memory), and the like, and controls each unit of the electronic timepiece 1. The CPU of the controller 11 reads a designated program from among a system program and various processing programs stored in the storage 12, deploys it in the RAM, and performs various processes in cooperation with the deployed program. For example, the controller 11 executes a mode switching process shown in FIG. 2 to FIG. 4. The controller 11 also displays a result of timekeeping by the timekeeper 16 on the display 14.

The controller 11 may include a plurality of CPUs. The plurality of processes executed by the controller 11 in the present embodiment may be executed by the plurality of CPUS. In this case, the plurality of CPUs may be involved in a common process. Alternatively, the of CPUS may plurality independently execute different processes in parallel.

The storage 12 is configured with a non-volatile memory or the like, and stores programs, data, and the like. The storage 12 is not limited to being provided inside the electronic timepiece 1, and may include an external storage medium that can be attached to and detached from the electronic timepiece 1. The storage 12 stores, for example, the system program of the electronic timepiece 1 and programs for executing various processes, including the mode switching process described below.

The operator 13 detects operations by the user and outputs signals to the controller 11 in response to the detected operations. The operator 13 includes, for example, a crown and a push button switch, and outputs signals corresponding to the operation of these to the controller 11. The operator 13 is also equipped with a tilt switch. The tilt switch outputs an ON signal to the controller 11 in a case in which the electronic timepiece 1 is set at a predetermined tilt (angle) by the user. According to the present embodiment, the tilt switch turns ON when a main body of the electronic timepiece 1 (display 14) becomes substantially horizontal and outputs an ON signal to the controller 11. In addition, the operator 13 may be equipped with a touch screen.

The display 14 is configured with a display device such as an LCD (Liquid Crystal Display) or an OLED (Organic Light Emitting Diode), and performs display based on control operation of the controller 11. The display 14 may include a dial with a second hand, minute hand, and hour hand, and may display the time of day by pointing with the hands to a scale on the dial.

The sensor section 15 includes at least an illuminance sensor 151 and an acceleration sensor 152, and outputs detection values by these sensors to the controller 11. The illuminance sensor 151 outputs the detection value of a brightness of the surroundings of the electronic timepiece 1 to the controller 11. The detection value showing the brightness of the surroundings of the electronic timepiece 1 output by the illuminance sensor 151 is brightness information about the brightness of the surroundings of the electronic timepiece 1. The illuminance sensor 151 functions as a brightness information acquirer. The acceleration sensor 152 outputs the detection value of acceleration in the three axial directions to the controller 11. The sensor section 15 may include other sensors such as a barometric pressure sensor, gyro sensor, GPS (Global Positioning System) sensor, etc.

The timekeeper 16 includes an oscillator circuit, a frequency divider circuit, a timekeeper circuit, etc. The timekeeper 16 measures the current date and time and outputs the measured result to the controller 11.

The communicator 17 performs communication control to communicate with an external device, such as a user's mobile terminal, for example, via Bluetooth (registered trademark).

The battery 18 is a primary or rechargeable secondary battery that supplies electric power to the various parts of the electronic timepiece 1. The electronic timepiece 1 may be configured with a solar panel to charge the battery 18.

Next, the operation of the electronic timepiece 1 in this embodiment will be described. FIG. 2 to FIG. 4 are flowcharts showing a flow of the mode switching process executed by the controller 11 of the electronic timepiece 1. The mode switching process is a process that switches between a normal mode (first mode) and a power saving mode (second mode). The power saving mode is a mode that operates with lower power consumption than the normal mode by, for example, turning off the screen display on the display 14 and partially stopping the movement of the hand of the timepiece. The mode switching process is executed by the controller 11 in cooperation with the program stored in the storage 12 while the power of the electronic timepiece 1 is turned on.

As shown in FIG. 2, in the mode switching process, the controller 11 first judges whether HALT is released (step S1). HALT is a mode in which the operation of the CPU of the controller 11 is suspended during periods when no processing is required, in order to suppress wasteful processing and reduce power consumption. HALT is released, for example, at interruptions or every predetermined amount of time, and the program is executed during the release.

In a case in which it is judged that HALT is not released (step S1; NO), the controller 11 returns to step S1. In a case in which it is judged that HALT has been released (step S1; YES), the controller 11 judges whether the device is operating in the power saving mode (step S2). In a case in which it is judged that the device is not operating in the power saving mode (i.e., it is operating in the normal mode) (step S2; NO), the controller 11 executes the judgment process for switching to the power saving mode (step S3). In a case in which it is judged that the device is operating in the power saving mode (step S2; YES), the controller 11 executes the judgment process for switching to the normal mode (step S4).

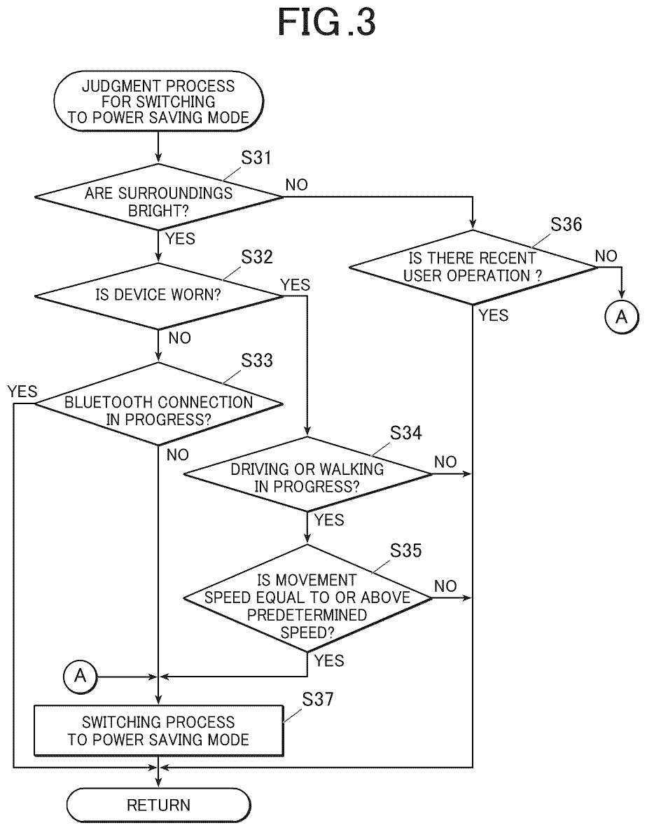

First, referring to FIG. 3, the judgment process for switching to the power saving mode, which is executed during operation in the normal mode, is described. In the judgment process to judge whether to switch to the power saving mode, the controller 11 judges whether the surroundings of the electronic timepiece 1 are bright or dark (bright or not bright). In a case in which the controller 11 judges that the surroundings are bright, the controller 11 judges whether to switch the operation mode from the normal mode to the power saving mode based on a light-time switching condition to switch from the normal mode to the power saving mode. The light-time switching condition is a condition set assuming a user behavior when the surroundings are bright. The light-time switching condition for switching from the normal mode to the power saving mode is the user behavior or a state of the electronic timepiece 1 that is assumed to have no or very little effect on the user even in a case in which the mode is switched to the power saving mode in bright surroundings, and includes the following (1) and (2).
(1) The electronic timepiece 1 is not worn by the user, and a communication connection is not established between the electronic timepiece 1 and the external device.
(2) The electronic timepiece 1 is worn by the user and the user is walking or running at or above a predetermined speed.

In a case in which the judgment process for switching to the power saving mode judges that the surroundings of the electronic timepiece 1 are dark, the controller 11 judges whether to switch the operation mode from the normal mode to the power saving mode based on a dark-time switching condition for switching from the normal mode to the power saving mode. The light-time switching condition and the dark-time switching condition are different from each other. The dark-time switching condition is a condition set assuming the user behavior when the surroundings are dark. The dark-time switching condition for switching from the normal mode to the power saving mode is the user behavior or the state of the electronic timepiece 1 that is assumed to have no or very little effect on the user in a case in which the mode is switched to the power saving mode in dark surroundings, and includes the following (3).
(3) The electronic timepiece 1 is not operated by the user recently for a predetermined amount of time.

As shown in FIG. 3, in the judgment process for switching to the power saving mode, the controller 11 first judges whether the surroundings of the electronic timepiece 1 are bright (step S31). For example, the controller 11 judges that the surroundings of the electronic timepiece 1 are bright in a case in which the detection value of the illuminance sensor 151 is equal to or above a predetermined threshold value. The controller 11 judges that the surroundings of the electronic timepiece 1 are dark in a case in which the detection value of the illuminance sensor 151 is below a predetermined threshold value. In a case in which the electronic device 1 is equipped with a solar panel, for example, it is possible to judge whether the surroundings of the electronic device 1 are bright based on whether an amount of electricity generated by the solar panel exceeds the threshold value.

In a case in which it is judged that the surroundings of the electronic timepiece 1 are bright (step S31; YES), the controller 11 judges whether the electronic timepiece 1 is worn (step S32). For example, in step S32, the controller 11 performs a behavior analysis to estimate the user's current behavior based on the detection value of the sensor section 15 (e.g., acceleration sensor 152), and judges whether the electronic timepiece 1 is worn based on the result of the behavior analysis. The behavior analysis estimates which of the following behaviors the user's movement corresponds to, for example, stopping, walking, running, bicycling, not wearing the electronic timepiece 1, or otherwise. For example, in a case in which the controller 11 judges that there is no movement at all in the electronic timepiece 1 for a certain amount of time based on the detection value of the acceleration sensor 152, the controller 11 judges that the electronic timepiece 1 is not worn. In a case in which the controller 11 judges that there is movement in the electronic timepiece 1, the controller 11 judges that the electronic timepiece 1 is worn. The behavior analysis may be performed using any of the known algorithms, and the methods are not limited.

In a case in which it is judged that the electronic timepiece 1 is not worn (step S32; NO), the controller 11 judges whether the electronic timepiece 1 is connected to the external device by Bluetooth (during communication connection) via the communicator 17 (step S33). In a case in which it is judged that the electronic timepiece 1 is not connected to the external device by Bluetooth (step S33; NO), the controller 11 judges to switch the mode to the power saving mode, performs the switching process to the power saving mode (step S37), and returns to step S1 in FIG. 2. In a case in which the electronic timepiece 1 is not worn and the electronic timepiece 1 is not connected to the external device such as the user's mobile device by Bluetooth, it is assumed that the user is in a place away from the electronic timepiece 1 and that the user will not see (use) the display of the electronic timepiece 1. Therefore, the controller 11 judges to switch the mode of the electronic timepiece 1 to the power saving mode in a case in which the electronic timepiece 1 is not worn and is not connected to the external device by Bluetooth. In the process of switching to the power saving mode, the controller 11 performs processes to reduce power consumption, for example, by not displaying the screen of the display 14 or stopping the movement of the hand of the timepiece.

In a case in which it is judged that the device is connected to the external device by Bluetooth (step S33; YES), the controller 11 judges not to switch the mode to the power saving mode and returns to step S1 in FIG. 2. Even if the electronic timepiece 1 is not worn, in a case in which the electronic timepiece 1 is connected to the external device such as the user's mobile terminal by Bluetooth, it is assumed that the user is beside the electronic timepiece 1 and is viewing (using) the display of the electronic timepiece 1. Therefore, the controller 11 judges to not switch to the power saving mode in a case in which the electronic timepiece 1 is not worn but is connected to the external device by Bluetooth.

In a case in which it is judged in step S32 that the electronic timepiece 1 is worn (step S32; YES), the controller 11 judges whether the user is walking or running by the behavior analysis (step S34). In a case in which it is judged that the user is walking or running (step S34; YES), the controller 11 judges whether a movement speed is equal to or above a predetermined speed (e.g., 15 km/h or faster) (step S35). In a case in which it is judged that the movement speed is equal to or above the predetermined speed (step S35; YES), the controller 11 judges to switch the mode to the power saving mode, performs the switching process to the power saving mode (step S37), and returns to step S1 in FIG. 2. It is assumed that even if the user is wearing the electronic timepiece 1, it is difficult for the user to see the display of the timepiece in a case in which the user is walking or running at or above a predetermined movement speed. Therefore, the controller 11 judges to switch the mode of the electronic timepiece 1 to the power saving mode in a case in which the controller 11 judges that the user is walking or running at or above the predetermined movement speed while wearing the electronic timepiece 1.

In a case in which it is judged in step S34 that the user is not walking or running (step S34; NO), or in a case in which it is judged in step S35 that the user's movement speed is below the predetermined speed (step S35; NO), the controller 11 judges not to switch the mode to the power saving mode and returns to step S1 in FIG. 2. It is assumed that the user may view (use) the display of the electronic timepiece 1 in a case in which the user is not walking or running or is walking or running at a speed below the predetermined movement speed while wearing the electronic timepiece 1. Therefore, the controller 11 judges not to switch the mode to the power saving mode in a case in which the controller 11 judges that the user is not walking or running or is walking or running at a speed below the predetermined movement speed while wearing the electronic timepiece 1.

In this way, the mode can be switched more appropriately by setting different switching conditions assuming the respective behaviors in a case in which the electronic timepiece 1 is worn by the user and in a case in which the electronic timepiece 1 is not worn by the user.

On the other hand, in a case in which it is judged in step S31 that the surroundings of the electronic timepiece 1 are dark (not bright) (step S31; NO), the controller 11 judges whether an operation of the operator 13 by the user was detected within a recent predetermined amount of time (step S36). The predetermined amount of time is, for example, about one hour. In a case in which it is judged that no operation of the operator 13 by the user has been detected within the recent predetermined amount of time (step S36; NO), the controller 11 judges to switch the mode to the power saving mode, performs the switching process to the power saving mode (step S37), and returns to step S1 in FIG. 2. In a case in which the surroundings of the electronic timepiece 1 are dark and the user not operating the electronic timepiece continues for a predetermined amount of time, it is assumed that it is night time and the user is not viewing (using) the electronic timepiece 1 for a long amount of time. Therefore, the controller 11 judges to switch the mode of the electronic timepiece 1 to the power saving mode in a case in which the controller 11 has not detected the operation by the user in the recent predetermined amount of time in a state that the surroundings of the electronic timepiece 1 are dark.

In a case in which the controller 11 judges in step S36 that the operation of the operator 13 by the user is detected within the recent predetermined amount of time (step S36; YES), the controller 11 judges not to switch the mode to the power saving mode and returns to step S1 in FIG. 2. In a case that there is an operation by the user in the recent predetermined amount of time, the user is using the electronic timepiece 1, and therefore the switch to the power saving mode is not made.

As described above, in the judgment process for switching to the power saving mode, which is executed during operation in the normal mode, the controller 11 judges whether the surroundings of the electronic timepiece 1 are bright or dark. In a case in which it is judged that the surroundings are bright, the controller 11 judges whether to switch the operation mode from the normal mode to the power saving mode based on the light-time switching condition for switching from the normal mode to the power saving mode. In a case in which it is judged that the surroundings are dark, the controller 11 judges whether to switch the operation mode from the normal mode to the power saving mode based on the dark-time switching condition for switching from the normal mode to the power saving mode. Therefore, since the controller 11 judges whether to switch to the power saving mode using different switching conditions that assume the user behavior for each of when the surroundings are bright and when the surroundings are dark, it is possible to more appropriately perform mode switching by judging the situation in which the user is not affected by switching to the power saving mode. Consequently, the power saving effect can be enhanced.

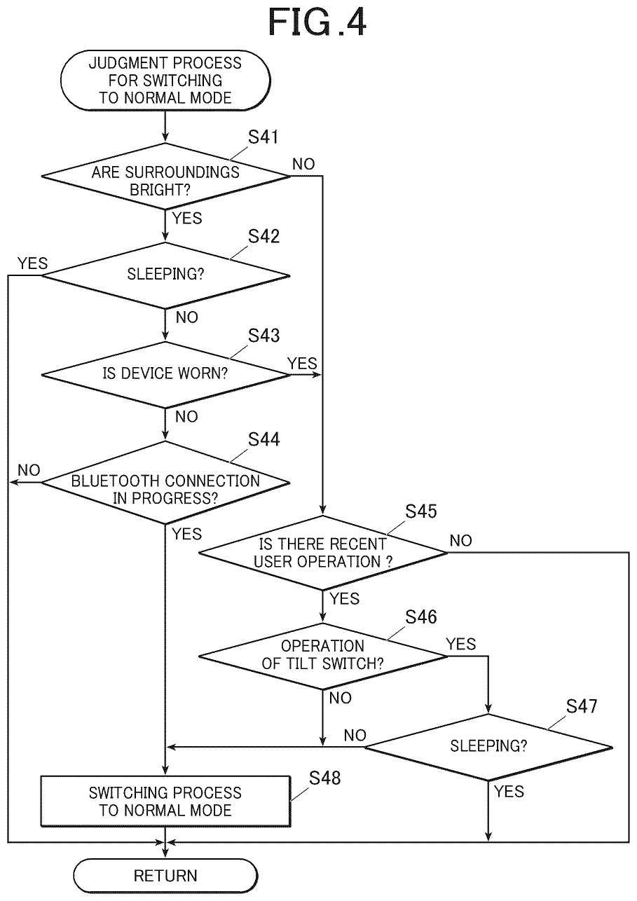

Referring to FIG. 4, the judgment process for switching to the normal mode, which is executed during operation in the power saving mode, is explained next. In the judgment process to judge whether to switch to the normal mode, the controller 11 judges whether the surroundings of the electronic timepiece 1 are bright or dark. In a case in which the controller 11 judges that the surroundings are bright, the controller 11 judges whether to switch the operation mode from the power saving mode to the normal mode based on the light-time switching condition to switch from the power saving mode to the normal mode. As described above, the light-time switching condition is the condition set assuming the user behavior when the surroundings are bright. The light-time switching condition for switching from the power saving mode to the normal mode is the user behavior or the state of the electronic timepiece 1 that is assumed that the user definitely uses (is using) the electronic timepiece 1 in a case in which the surroundings are bright, and includes the following (4) and (5).
(4) The user is not sleeping and the electronic timepiece 1 is not worn, but the communication connection is in progress with the external device.
(5) The user is not sleeping and is wearing the electronic timepiece 1, and the electronic timepiece 1 detects the user operation.

In the judgment process to judge whether to switch to the normal mode, the controller 1 judges whether the surroundings of the electronic timepiece 1 are bright or dark. In a case in which the controller 11 judges that the surroundings are dark, the controller 11 judges whether to switch the operation mode from the power saving mode to the normal mode based on the dark-time switching condition to switch from the power saving mode to the normal mode. As described above, the dark-time switching condition is the condition set assuming the user behavior when the surroundings are dark. The dark-time switching condition for switching from the power saving mode to the normal mode is the user behavior or the state of the electronic timepiece 1 that is assumed that the user definitely uses (is using) the electronic timepiece 1 in a case in which the surroundings are dark, and includes the following (6) and (7).
(6) User operation other than the tilt switch is detected in the electronic timepiece 1.
(7) Operation of the tilt switch is detected in the electronic timepiece 1 and the user is not sleeping.

As shown in FIG. 4, in the judgment process for switching to the power saving mode, the controller 11 first judges whether the surroundings of the electronic timepiece 1 are bright (step S41). For example, the controller 11 judges that the surroundings of the electronic timepiece 1 are bright in a case in which the value detected by the illuminance sensor 151 is equal to or above a predetermined threshold value. The controller 11 judges that the surroundings of the electronic timepiece 1 are dark in a case in which the value detected by the illuminance sensor 151 is below a predetermined threshold value.

In a case in which it is judged that the surroundings of the electronic timepiece 1 are bright (step S41; YES), the controller 11 judges whether the user is sleeping (step 42). For example, the controller 11 judges whether the user is sleeping based on the user's arm movements obtained from the detection value of the acceleration sensor 152. The judgment of whether a person is sleeping may be made using any of the known algorithms, and is not limited to any particular algorithm. In a case in which it is judged that the user is sleeping (step S42; YES), the controller 11 judges not to switch the mode to the normal mode and returns to step S1 in FIG. 2. In a case in which the user is sleeping even though the surroundings are bright, the controller 11 does not switch the mode of the electronic timepiece 1 to the power saving mode because the user does not view or use the display of the electronic timepiece 1.

In a case in which it is judged that the user is not sleeping (step S42; NO), the controller 11 judges whether the electronic timepiece 1 is worn (step S43). As described above, whether the electronic timepiece 1 is worn can be judged by the behavior analysis based on the detection value of the sensor section 15. In a case in which it is judged that the electronic timepiece 1 is worn (step S43; YES), the controller 11 moves to step S45.

In a case in which it is judged that the electronic timepiece 1 is not worn (step S43; NO), the controller 11 judges whether the electronic timepiece 1 is connected to the external device by Bluetooth via the communicator 17 (step S44). In a case in which it is judged that the device is not connected to the external device by Bluetooth (step S44; NO), the controller 11 judges not to switch the mode to the normal mode and returns to step S1 in FIG. 2. In a case in which the electronic timepiece 1 is not worn and not connected to the external device such as the user's mobile device by Bluetooth, it is assumed that the user is in a place away from the electronic timepiece 1 and that the user will not see (use) the display of the electronic timepiece 1. Therefore, even if the surroundings of the electronic timepiece 1 are bright, the controller 11 judges to not switch to the normal mode in a case in which the electronic timepiece 1 is not worn and is not connected to the external device by Bluetooth.

In a case in which it is judged that the electronic timepiece 1 is connected to the external device by Bluetooth in step S44 (step S44; YES), the controller 11 judges to switch the mode to the normal mode, performs the switching process to the normal mode (step S48), and returns to step S1 in FIG. 2. In the process of switching to the normal mode, the controller 11 performs the processes such as, displaying the screen of the display 14, resuming movement of the hand of the timepiece, etc. Even if the electronic timepiece 1 is not worn, in a case in which the electronic timepiece 1 is connected to the external device by Bluetooth, it is assumed that the user is beside the electronic timepiece 1 and is viewing (using) the display of the electronic timepiece 1. Therefore, the controller 11 switches to the normal mode in a case in which the electronic timepiece 1 is not worn but is still connected to the external device via Bluetooth.

On the other hand, in a case in which it is judged in step S41 that the surroundings of the electronic timepiece 1 are dark (not bright) (step S41; NO), or in a case in which it is judged in step S43 that the electronic timepiece 1 is worn (step S43; YES), the controller 11 judges whether the operation of the operator 13 by the user is detected within the recent predetermined amount of time (step S45). The predetermined amount of time is, for example, one hour, as described above. In a case in which it is judged that no operation of the operator 13 by the user has been detected in the recent predetermined amount of time (step S45; NO), the controller 11 judges not to switch the mode to the normal mode, and returns to step S1 in FIG. 2. In a case in which the surroundings of the electronic timepiece 1 are dark and the user not operating the electronic timepiece continues for a predetermined amount of time, it is assumed that it is night time and the user is not viewing (using) the display of the electronic timepiece 1 for a long amount of time. Therefore, the controller 11 judges to not switch the mode of the electronic timepiece 1 to the normal mode in a case in which there is no user operation for a predetermined amount of time in a case in which the surroundings of the electronic timepiece 1 are dark.

In a case in which it is judged in step S45 that the operation of the operator 13 by the user is detected in the recent predetermined amount of time (step S45; YES), the controller 11 judges whether the operation is a tilt switch operation (step S46). In a case in which it is judged that the operation is an operation other than the tilt switch (step S46; NO), the controller 11 judges to switch the mode to the normal mode, performs the switching process to the normal mode (step S48), and returns to step S1 in FIG. 2. Although the tilt switch may be operated unintentionally by the user during sleep, operations other than the tilt switch on the operator 13, such as push button switches and a crown, are intended by the user. In other words, it is assumed that the user is trying to view (use) the display of the electronic timepiece 1 when there is an operation other than the tilt switch, even when the surroundings of the electronic timepiece 1 are dark. Therefore, the controller 11 performs the switching process to the normal mode in a case in which the operation other than the tilt switch in the operator 13 is detected, even when the surroundings of the electronic timepiece 1 are dark.

In a case in which it is judged in step S46 that the operation is an operation of the tilt switch (step S46; YES), the controller 11 judges whether the user is sleeping based on the detection value of the acceleration sensor 152 (step S47). In a case in which it is judged that the user is sleeping (step S47; NO), the controller 11 judges not to switch the mode to the normal mode and returns to step S1 in FIG. 2. If the user performs the operation in a state in which the surroundings of the electronic timepiece 1 are dark, in a case in which the tilt switch is operated and the user is sleeping, it is assumed that the operation is most likely to be performed by turning over while sleeping. Therefore, even if the user performs an operation in a state in which the surroundings of the electronic timepiece 1 are dark, the controller 11 does not switch to the normal mode in a case in which the user operates the tilt switch and the user is sleeping.

In a case in which it is judged in step S47 that the user is not sleeping (step S47; NO), the controller 11 judges to switch the mode to the normal mode, performs the switching process to the normal mode (step S48), and returns to step S1 in FIG. 2. Even if the surroundings of the electronic timepiece 1 are dark, in a case in which the tilt switch is operated and the user is not sleeping, it is assumed that the user is trying to view the display of the electronic timepiece 1. Therefore, the controller 11 performs the switching process to the normal mode in a case in which the tilt switch is operated and the user is not sleeping, even when the surroundings of the electronic timepiece 1 are dark.

As described above, in the judgment process for switching to the normal mode, which is executed during the operation in the power saving mode, the controller 11 judges whether the surroundings of the electronic timepiece 1 are bright or dark. In a case in which it is judged that the surroundings are bright, the controller 11 judges whether to switch the operation mode from the power saving mode to the normal mode based on the light-time switching condition for switching from the power saving mode to the normal mode. In a case in which it is judged that the surroundings are dark, the controller 11 judges whether to switch the operation mode from the normal mode to the power saving mode based on the dark-time switching condition for switching from the power saving mode to the normal mode. Therefore, since the controller 11 judges whether to switch to the normal mode using different switching conditions that assume the user behavior for each of when the surrounding are bright and when the surrounding are dark, it is possible to more appropriately judge the situation in which the mode should be switched to the normal mode. Consequently, unnecessary switching to the normal mode can be prevented, and the power saving effect can be enhanced.

For example, Japanese Unexamined Patent Application Publication No. 2017-68499 discloses an electronic device that acquires position information or posture information of the user, judges the state of the user based on the acquired position or posture information, and switches the mode from the normal mode to the power saving mode according to the judgment result. However, the expected user behavior differs when it is bright or dark. Therefore, if judging whether to switch modes is performed under the same conditions regardless of whether it is bright or dark, there is a problem that extra power is consumed because the mode is set to the normal mode in situations where the user is not using the electronic device or unnecessary judgment processing is performed.

To address this problem, the controller 11 of the electronic timepiece 1 acquires the detection value of the illuminance sensor 151 and judges whether the acquired detection value is equal to or above the predetermined threshold value or below the predetermined threshold value, that is, whether the surroundings of the electronic timepiece 1 are bright or dark. In a case in which it is judged that the surroundings of the electronic timepiece 1 are bright, the controller 11 judges to switch between the normal mode and the power saving mode based on the light-time switching condition, assuming the user behavior when the surroundings are bright. In a case in which it is judged that the surroundings of the electronic timepiece 1 are dark, the controller 11 judges to switch between the normal mode and the power saving mode based on the dark-time switching condition, assuming the user behavior when the surroundings are dark. Therefore, since the mode switching is judged using different switching conditions that assume the user behavior in each of when the surroundings are bright and when the surroundings are dark, the mode switching can be performed more appropriately when it is bright and when it is dark, thereby enhancing the power saving effect.

For example, in a case in which the controller 11 judges that the surroundings of the electronic timepiece 1 are bright, the controller 11 judges whether the electronic timepiece 1 is worn by the user, and applies different switching conditions between a case in which it is judged that the electronic timepiece 1 is worn by the user and a case in which it is judged that the electronic timepiece 1 is not worn by the user. Therefore, the mode can be switched more appropriately by assuming different switching conditions for the behavior when the electronic timepiece 1 is worn and the behavior when the electronic timepiece 1 is not worn.

For example, in a case in which the controller 11 judges that the surroundings of the electronic timepiece 1 are bright when the electronic timepiece 1 is in the normal mode and the controller 11 judges that the electronic timepiece 1 is not worn by the user and the electronic timepiece 1 is not connected to the external device for communication, the controller 11 switches the mode of the electronic timepiece 1 from the normal mode to the power saving mode. Therefore, in a case in which the surroundings are bright, the mode is switched to the power saving mode in a situation that is assumed that the user is obviously not near the electronic timepiece 1. Therefore, the user does not feel annoyed by the shift to the power saving mode when the user is viewing (using) the display of the electronic timepiece 1. Consequently, the power saving effect is enhanced.

For example, in a case in which the controller 11 judges that the surroundings of the electronic timepiece 1 are bright when the electronic timepiece 1 is in the normal mode, and that the user is performing a predetermined action while wearing the electronic timepiece 1, the controller 11 causes the electronic timepiece 1 to switch from the normal mode to the power saving mode. Thus, even in a case in which the user is wearing the electronic timepiece 1 in bright surroundings, the mode can be switched to the power saving mode in situations where the user is acting in a way that the user cannot view the display, thereby enhancing the power saving effect.

For example, in a case in which the controller 11 judges that the surroundings of the electronic timepiece 1 are dark when the electronic timepiece 1 is in the power saving mode, and that the user is not sleeping and the operation by the user is detected on the electronic timepiece 1, the controller 11 causes the electronic timepiece 1 to switch from the power saving mode to the normal mode. Therefore, in a case in which the surroundings are dark, the mode does not switch to the normal mode when the user is sleeping even if there is user operation, thus preventing returning to the normal mode due to unintended user operation such as turning over while sleeping, thereby enhancing the power saving effect.

For example, in a case in which the controller 11 judges that the surroundings of the electronic timepiece 1 are bright when the mode is in the power saving mode, the controller 11 does not switch the mode from the power saving mode to the normal mode if the user is sleeping. Thus, it is possible to prevent the mode from returning to the normal mode while the user is sleeping, which is when it is clear that the user does not view or use the display of the electronic timepiece 1, thereby enhancing the power saving effect.

In addition, the light-time switching condition and the dark-time switching condition are different when switching from the normal mode to the power saving mode and when switching from the power saving mode to the normal mode. Therefore, the mode switching can be performed under conditions suitable for switching from the normal mode to the power saving mode and from the power saving mode to the normal mode, respectively.

The description in the above embodiments is a suitable example of an embodiment of the electronic device, program, and mode switching method of the present invention, and is not limited thereto.

For example, according to the above embodiment, in a case in which it is judged that the surroundings of the electronic timepiece 1 are dark when the electronic timepiece 1 is operating in the power saving mode, and an operation other than the tilt sensor of the operator 13 is detected, this is considered to be an operation intended by the user and the mode is switched to the normal mode. However, some models (types) of the electronic timepieces 1 are designed so that the push button switch is easily turned on in order to emphasize operability. In such models, the push button switch may be turned on when the user turns over while sleeping. Therefore, it is possible to classify and store models with the push button switches that are easily operated and models with hard push button switches in the storage 12, and in the switching process to the normal mode, the dark-time switching condition for switching from the power saving mode to the normal mode may be varied according to the model of the electronic timepiece 1. For example, in a case in which the electronic timepiece 1 is a model with a hard push button switch, as shown in FIG. 4, the controller 11 judges to switch the mode from the power saving mode to the normal mode in a case in which the operation other than the tilt switch of the operator 13 is detected or the operation of the tilt switch is detected and the user is not sleeping (first condition). In a case in which the electronic timepiece 1 is a model in which the button switch is easily operated, the controller 11 judges to switch the mode from the power saving mode to the normal mode in a case in which the operation of the operator 13 (including the push button switch and the tilt switch) is detected and the user is not sleeping (second condition). This can prevent switching to the normal mode in a case in which the user unintentionally performs the operation by turning over while sleeping. The user may be able to set whether the above first or second condition is used as the dark-time switching condition for switching from the power saving mode to the normal mode by operating the operator 13.

According to the above embodiment, in a case in which the controller 11 judges that the surroundings of the electronic timepiece 1 are bright during operation in the normal mode, the controller 11 performs the judgment process of steps S32 to S35 in FIG. 3. In a case in which the light-time switching condition is satisfied, the controller 11 switches the mode from the normal mode to the power saving mode. However, some users do not want to shift to the power saving mode when it is bright. Therefore, a setting section (setter) may be provided for the user to set by the operation of operator 13 whether to switch the mode from the normal mode to the power saving mode based on the light-time switching condition or not to switch the mode from the normal mode to the power saving mode in a case in which it is judged that the surroundings of the electronic timepiece 1 are bright. With this, it is possible to judge whether to switch from the normal mode to the power saving mode according to user preferences.

According to the above embodiment, the light-time switching condition for switching from the normal mode to the power saving mode is that the electronic timepiece 1 is not worn by the user and that the electronic timepiece 1 is not connected to the external device. However, only the condition that the electronic timepiece 1 is not worn by the user may be used as the light-time switching condition. This allows the electronic timepiece 1 to switch to the power saving mode if the electronic timepiece 1 is not worn by the user in a case in which the surroundings are bright, thereby enhancing the power saving effect.

According to the above embodiment, Bluetooth was used for communication between the electronic timepiece 1 and external devices, but other communication methods may be used.

In the above embodiment, the case in which the electronic device of the present disclosure is the electronic timepiece 1 is described, but the electronic device is not limited to the electronic timepiece 1 and may be other electronic devices such as smartphones, for example.

According to the above description, a semiconductor memory or HDD can be used as the computer readable storage medium storing the program regarding the above disclosure but the examples are not limited to the above. As the computer readable medium, a portable recording/storage medium, such as a CD-ROM, can also be used. A carrier wave is also applied as a medium providing the program data according to the present invention via a communication line.

Although embodiments and the modification examples of the present disclosure have been described above, the scope of the present disclosure is not limited to the embodiments and modification examples described above, but includes the scope of the invention described in the claims and their equivalents.

What is claimed is:

1. An electronic device comprising:
a brightness information acquirer that acquires brightness information regarding brightness of surroundings of the electronic device; and
a controller that performs at least one judgment to switch a mode of the electronic device from a first mode to a second mode which operates with lower power consumption than the first mode or to switch the mode from the second mode to the first mode based on a different switching condition between a case in which it is judged that the surroundings of the electronic device are bright and a case in which it is judged that the surroundings of the electronic device are not bright based on the acquired brightness information.

2. The electronic device according to claim 1, wherein,
in a case in which the controller judges that the surroundings of the electronic device are bright, the controller judges whether the electronic device is worn by a user, and
the switching condition is further different between a case in which it is judged that the electronic device is worn by the user and a case in which it is judged that the electronic device is not worn by the user.

3. The electronic device according to claim 1, wherein the controller switches the mode of the electronic device from the first mode to the second mode in a case in which it is judged that the electronic device is in the first mode, that the surroundings of the electronic device are bright, and that the electronic device is not worn by a user and the electronic device is not connected to communicate with an external device.

4. The electronic device according to claim 1, wherein the controller switches the mode of the electronic device from the first mode to the second mode in a case in which it is judged that the electronic device is in the first mode, that the surroundings of the electronic device are bright, and that the electronic device is worn by a user and the user is performing a predetermined action.

5. The electronic device according to claim 4, wherein the predetermined action is that the user is walking or running at a predetermined speed.

6. The electronic device according to claim 1, wherein the controller switches the mode of the electronic device from the second mode to the first mode in a case in which it is judged that the electronic device is in the second mode, that the surroundings of the electronic device are not bright, and that an operation by a user is detected in the electronic device and the user is not sleeping.

7. The electronic device according to claim 1, wherein the controller does not switch the mode of the electronic device from the second mode to the first mode in a case in which it is judged that the electronic device is in the second mode, that the surroundings of the electronic device are bright, and that a user is sleeping.

8. The electronic device according to claim 1, wherein the switching condition is different between when the mode is switched from the first mode to the second mode and when the mode is switched from the second mode to the first mode.

9. The electronic device according to claim 1, further comprising a setter with which a user sets whether to switch from the first mode to the second mode based on the switching condition or not to switch from the first mode to the second mode.

10. The electronic device according to claim 1, wherein, the controller judges that the surroundings of the electronic device are bright in a case in which the brightness information is equal to or above a predetermined threshold value and that the surroundings of the electronic device are not bright in a case in which the brightness information is below the predetermined threshold value.

11. A non-transitory computer-readable storage medium that stores a program that can be executed by a controller of a computer of an electronic device, the program causing the controller to,
perform at least one judgment to switch a mode of the electronic device from a first mode to a second mode which operates with lower power consumption than the first mode or to switch the mode from the second mode to the first mode based on a different switching condition between a case in which it is judged that surroundings of the electronic device are bright and in a case in which it is judged that the surroundings of the electronic device are not bright based on brightness information acquired by a brightness information acquirer that acquires the brightness information regarding brightness of the surroundings of the electronic device.

12. The storage medium according to claim 11, wherein
in a case in which the controller judges that the surroundings of the electronic device are bright, the controller judges whether the electronic device is worn by a user, and
the switching condition is further different between a case in which it is judged that the electronic device is worn by the user and a case in which it is judged that the electronic device is not worn by the user.

13. A mode switching method executed by an electronic device of a computer, the method comprising:
performing at least one judgment to switch a mode of the electronic device from a first mode to a second mode which operates with lower power consumption than the first mode or to switch the mode from the second mode to the first mode based on a different switching condition between a case in which it is judged that surroundings of the electronic device are bright and in a case in which it is judged that the surroundings of the electronic device are not bright based on brightness information acquired by a brightness information acquirer that acquires the brightness information regarding brightness of the surroundings of the electronic device.

14. The mode switching method according to claim 13, wherein,
in a case in which it is judged that the surroundings of the electronic device are bright, it is judged whether the electronic device is worn by a user, and
the switching condition is further different between a case in which it is judged that the electronic device is worn by the user and a case in which it is judged that the electronic device is not worn by the user.
